(19) United States
(12) Patent Application Publication
(10) Pub. No.: US 2024/0059801 A1
(43) Pub. Date: Feb. 22, 2024

(54) PROCESSES FOR POLYMERIZING ONE OR MORE OLEFINS

(71) Applicant: ExxonMobil Chemical Patents Inc., Baytown, TX (US)

(72) Inventors: Ryan W. IMPELMAN, Houston, TX (US); Bruce J. SAVATSKY, Kingwood, TX (US); Richard E. PEQUENO, Baytown, TX (US); Xuan YE, Houston, TX (US); Stacy N. APUGO, Houston, TX (US)

(21) Appl. No.: 18/260,201

(22) PCT Filed: Jan. 10, 2022
(86) PCT No.: PCT/US2022/070113

§ 371 Date: Jun. 30, 2023

Related U.S. Application Data
(60) Provisional application No. 63/200,051, filed on Feb. 11, 2021.

(51) Int. Cl. C08F 2/34; C08F 2/01; C08F 210/14; C08F 4/659; C08F 4/6592

(52) U.S. Cl. CPC C08F 2/34; C08F 2/01; C08F 210/14; C08F 4/65904; C08F 4/65927; C08F 4/65916; C08F 4/65912

(57) ABSTRACT

Polymerization processes. In some embodiments, the polymerization process can include introducing a carrier fluid, an olefin, and a catalyst feed into a polymerization reactor, wherein the catalyst feed comprises one or more catalysts, a carrier liquid and optionally an induced condensing agent. In some embodiments, a combined amount of the carrier liquid and any induced condensing agent in the catalyst feed is ≥350 kg per mole of the one or more catalysts introduced into the polymerization reactor. The process can also include polymerizing the olefin in the presence of the catalyst within the polymerization reactor to produce a polymer product.

### CROSS-REFERENCE TO RELATED APPLICATION

This application claims the benefit of U.S. Provisional Application 63/200,051 filed Feb. 11, 2021, entitled “Processes for Polymerizing One or More Olefins”, the entirety of which is incorporated by reference herein.

### FIELD

This disclosure relates to processes for polymerizing one or more olefins.

### BACKGROUND

Gas-phase polymerization is useful for polymerizing ethylene or ethylene and one or more co-monomers. Polymerization processes in fluidized beds are particularly economical. One or more olefin monomers and catalyst particles can be introduced into a polymerization reactor where the olefin(s) can polymerize in the presence of the catalyst particles to produce a polymer product.

During polymerization the catalyst particles can begin to overheat, especially when the catalyst particles have an aggressive kinetic profile. When the catalyst particles overheat, the polymer particles within the reactor can begin to stick together, which leads to the buildup of polymer within the reactor. The buildup of polymer, which is usually referred to as agglomeration, chunking, or sheeting of the polymer within the reactor, can cause process upsets such as a reactor shutdown.

Some references of potential interest in this area include: U.S. Pat. Nos. 6,825,287; 6,689,847; 6,608,149; 6,605,675; 6,908,971; 7,803,324; 7,980,264; 7,973,112; 7,989,562; 8,962,775; as well as US Patent Pub. Nos. US2010/0041841, US2018/0155474, US2019/0119413, US2019/0176118; and further including WIPO Publications WO 1996/009328, WO2019/182746, WO2019/027585, and WO2020/092599.

There is a need for improved processes for polymerizing one or more olefins in polymerization reactors that can reduce or eliminate polymer buildup within the reactor. This disclosure satisfies this and other needs.

### SUMMARY

Processes for polymerizing one or more olefins are provided. In some embodiments, the polymerization process can include introducing an olefin and a catalyst feed into a polymerization reactor. The catalyst feed may comprise a catalyst and a carrier liquid, and optionally may further comprise one or both of a carrier fluid and an induced condensing agent. A combined amount of the carrier liquid and any induced condensing agent in the catalyst feed can be ≥350 kg per mole of the catalyst introduced into the polymerization reactor in the catalyst feed. The process can also include polymerizing the olefin in the presence of the catalyst within the polymerization reactor to produce a polymer product.

In some embodiments, the polymerization process can include introducing an olefin and a catalyst feed into a polymerization reactor. The catalyst feed includes carrier liquid and a catalyst, and optionally also includes one or both of a carrier fluid and an induced condensing agent. A combined amount of the carrier liquid and any induced condensing agent in the catalyst feed can be equal to a first amount per mole of the catalyst introduced into the polymerization reactor in the catalyst feed. The process can also include polymerizing the olefin in the presence of the catalyst within the polymerization reactor to produce a polymer product. Polymer sheets can be formed within the polymerization reactor at a rate greater than a pre-determined rate of polymer sheet formation. The process can further include reducing the rate of polymer sheet formation within the polymerization reactor by increasing the combined amount of the carrier liquid and any induced condensing agent in the catalyst feed to a second amount per mole of the catalyst introduced into the polymerization reactor. The second amount can be sufficient to reduce the rate of polymer sheet formation to less than the pre-determined rate.

### BRIEF DESCRIPTION OF THE DRAWING

FIG. 1 depicts a schematic of an illustrative gas-phase reactor system, according to one or more embodiments described.

FIG. 2 depicts a schematic of an illustrative nozzle, according to one or more embodiments described.

FIG. 3 depicts a cross-sectional view an illustrative gas-phase reactor that includes a plurality of the nozzles shown in FIG. 2, according to one or more embodiments described.

### DETAILED DESCRIPTION

Various specific embodiments, versions and examples of the invention will now be described, including preferred embodiments and definitions that are adopted herein for purposes of understanding the claimed invention. While the following detailed description gives specific preferred embodiments, those skilled in the art will appreciate that these embodiments are exemplary only, and that the invention may be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

As used herein, the indefinite article “a” or “an” shall mean “at least one” unless specified to the contrary or the context clearly indicates otherwise. Thus, embodiments using “an alpha-olefin” include embodiments where one, two or more alpha-olefins are used, unless specified to the contrary or the context clearly indicates that only one alpha-olefin is used.

Unless otherwise indicated, all numbers indicating quantities in this disclosure are to be understood as being modified by the term “about” in all instances. It should also be understood that the precise numerical values used in the specification and claims constitute specific embodiments.

As used herein, “wt %” means percentage by weight, “vol %” means percentage by volume, “mol %” means percentage by mole, “ppm” means parts per million, and “ppm wt” and “wppm” are used interchangeably and mean parts per million on a weight basis. All concentrations herein, unless otherwise stated, are expressed on the basis of the total amount of the composition in question.

An “olefin” is a linear, branched, or cyclic compound of carbon and hydrogen having at least one double bond. For purposes of this specification and the claims appended thereto, when a polymer or copolymer is referred to as including an olefin, e.g., ethylene and at least one C₃ to C₂₀ α-olefin, the olefin present in such polymer or copolymer is the polymerized form of the olefin. For example, when a copolymer is said to have an “ethylene” content of about 35 wt % to about 55 wt %, it is understood that the repeating unit/mer unit or simply unit in the copolymer is derived from ethylene in the polymerization reaction and the derived units are present at about 35 wt % to about 55 wt %, based on a weight of the copolymer. For the purposes of the present disclosure, ethylene shall be considered an α-olefin.

A “polymer” has two or more of the same or different repeating units/mer units or simply units. A “homopolymer” is a polymer having units that are the same. A “copolymer” is a polymer having two or more units that are different from each other. A “terpolymer” is a polymer having three units that are different from each other. The term “different” as used to refer to units indicates that the units differ from each other by at least one atom or are different isomerically. The definition of copolymer, as used herein, includes terpolymers and the like. Likewise, the definition of polymer, as used herein, includes homopolymers, copolymers, and the like. Furthermore, the terms “polyethylene copolymer”, “ethylene copolymer”, and “ethylene-based polymer” are used interchangeably to refer to a copolymer that includes at least 50 mol % of units derived from ethylene.

For the purposes of this disclosure, the nomenclature of elements is pursuant to the NEW NOTATION version of the Periodic Table of Elements as provided in Hawley's Condensed Chemical Dictionary, 16th Ed., John Wiley & Sons, Inc., (2016), Appendix V unless otherwise noted.

The term, “catalyst” can be used interchangeably with the terms “catalyst compound,” “catalyst precursor,” “transition metal compound,” “transition metal complex,” and “pre-catalyst.”

The terms “anti-static agent”, “continuity additive”, “continuity aid”, and “antifoulant agent” are interchangeable and refer to compounds or mixtures of compounds, such as solids and/or liquids, that are useful in polymerization to reduce fouling of the reactor. Fouling of the reactor is caused by polymer buildup within the reactor. Fouling of the reactor can be manifested by any number of phenomena including sheeting of the reactor walls, plugging of inlet and outlet lines, formation of large agglomerates, or other forms of polymer build up within the reactor that can lead to a shutdown of the reactor. The anti-static agent can be used as a part of the catalyst composition or introduced directly into the reactor independent of the catalyst composition. In some embodiments, the anti-static agent can be supported on a support that also supports one or more catalysts.

“Alkoxides” include an oxygen atom bonded to an alkyl group that is a C₁ to C₁₀ hydrocarbyl. The alkyl group may be straight chain, branched, or cyclic. The alkyl group may be saturated or unsaturated. In at least one embodiment, the alkyl group may comprise at least one aromatic group.

### Polymerization Process

A catalyst feed and one or more olefins, potentially among other streams, can be introduced into a polymerization reactor. The catalyst feed can include at least a carrier liquid and a catalyst; further, the catalyst feed can optionally include one or more induced condensing agents and/or a carrier fluid (in addition to the carrier liquid and catalyst). In some embodiments, the carrier liquid can be or can include, but is not limited to, one or more mineral oils or one or more mineral oils and one or more waxes. The olefin can be polymerized in the presence of the catalyst within the polymerization reactor to produce a polymer product. In particular embodiments, as discussed below, the polymerization reactor may be a gas phase polymerization reactor, and in particular a gas phase fluidized bed polymerization reactor. Further, in these and other embodiments, the catalyst feed may be formed from one or more catalyst-containing mixtures. Examples of catalyst-containing mixtures, also discussed in some more detail below, include catalyst slurries (a slurry formed from carrier liquid, such as mineral oil and/or wax, and solids including catalyst (supported or unsupported) and activators); and also include catalyst solutions (containing, for example, carrier liquid and unsupported catalyst, and optionally also containing activator).

It has been discovered that by increasing (1) the amount of the carrier liquid, (2) the amount of any induced condensing agent, or the amount of both (1) and (2) in the catalyst feed introduced into the polymerization reactor, the likelihood of polymer buildup (sometimes referred to as “sheeting”) within the reactor can be significantly reduced or even eliminated.

In some embodiments, a combined amount of the carrier liquid and any induced condensing agent in the catalyst feed can be ≥350 kg, ≥375 kg, ≥400 kg, ≥425 kg, ≥450 kg, ≥475 kg, ≥500 kg, ≥525 kg, ≥550 kg, ≥575 kg, ≥600 kg, ≥625 kg, ≥650 kg, ≥675 kg, or ≥700 kg to 800 kg, 900 kg, 1,000 kg, 1,100 kg, 1,200 kg, 1,300 kg, 1,350 kg, 1,400 kg, or 1,450 kg per mole of the catalyst in the catalyst feed introduced into the polymerization reactor. The amounts can also or instead be represented by a weight ratio of the combined amount of the carrier liquid and any induced condensing agent to the catalyst in the catalyst feed. Such weight ratio can be ≥13:1, ≥14:1, ≥, 15:1, ≥16:1, ≥17:1, ≥17:1, ≥18:1, ≥19:1, ≥20:1, ≥21:1, ≥22:1, ≥23:1, ≥24:1, or ≥25:1 on the low end, and may range on the high end to ≤50:1, ≤47:1, ≤45:1, ≤43:1, ≤40:1, ≤37:1, ≤35:1, ≤33:1, or ≤30:1, with ranges from any foregoing low end to any foregoing high end contemplated (e.g., weight ratio between 13:1 and 50:1, inclusive; such as between 20:1 and 40:1). As used herein, ratios to mol of catalyst or weight of catalyst are on the basis of all catalyst supplied to the polymerization reactor in the catalyst feed; thus, where a catalyst system comprising multiple different catalyst compounds is supplied to the polymerization reactor in the catalyst feed, the just-mentioned weight ratios and weight-to-mol amounts are in terms of weight (or mol) of all catalyst compounds supplied to the polymerization reactor. For simplicity, discussion herein will often reference the “catalyst”—this is meant to include the situation where the “catalyst” includes multiple catalyst compounds (e.g., 2 or more metallocene catalyst compounds; or a metallocene catalyst compound and a Ziegler-Natta catalyst compound, etc.), unless specifically noted otherwise.

Furthermore, references to moles of catalyst are to the catalyst compound(s) itself/themselves, exclusive of activators, supports and the like that may also be present in the catalyst feed. Thus, where 1 mole of metallocene catalyst is deposited on 5 moles of support and combined with 1 mole of activator in the catalyst feed, and the resulting supported/activated catalyst composition is fed into the reactor, the relative amount of carrier liquid and induced condensing agent in the catalyst feed (whether in kg per mol catalyst or in weight ratio) is determined on the basis of the 1 mole of catalyst (and/or its corresponding weight), not counting the 5 moles of support and 1 mole of activator also in the catalyst feed.

It is also noted that some chemical constituents of the catalyst feed (e.g., the optional induced condensing agent, such as alkanes, and/or optional carrier fluid, such as nitrogen) may additionally be fed to the polymerization reactor via other means. For example, induced condensing agents in gas phase polymerization processes, and in particular fluidized bed gas phase polymerization processes, are frequently provided to the process in a cycle gas flowing up through the fluidized bed in the polymerization reactor (although they may also be provided in other streams that are not the catalyst feed or the cycle gas). These induced condensing agents (and/or other compounds) that are duplicative of components of the catalyst feed, but fed to the polymerization reactor separately from the catalyst feed, are not included in the above-noted calculations of “combined amount of the carrier liquid and any induced condensing agent in the catalyst feed.”

In some embodiments, the catalyst feed (including the catalyst, the carrier liquid, and any optional induced condensing agent) can be introduced into the polymerization reactor via a single nozzle or via two or more nozzles, e.g., 2, 3, 4, or more nozzles. It is also contemplated that different catalyst feeds (e.g., catalyst feeds having different compositions) may be introduced via two or more nozzles. When two different catalyst feeds are introduced into the polymerization reactor via two or more nozzles, respectively, the total of all carrier liquid and any induced condensing agent across the catalyst feeds, and the total of all catalyst compounds across the catalyst feeds, are each added together (on basis of the same flow rate) for determining the total amount of carrier liquid and induced condensing agent per mole catalyst provided in the catalyst feed(s). Thus, where a first catalyst feed fed through a first nozzle includes 260 kg/hr of carrier liquid and condensing agent fed per mol catalyst, and a second catalyst feed fed through a second nozzle includes 360 kg/hr of carrier liquid and condensing agent per mol catalyst, the total amount (620 kg) is divided by 2 moles catalyst, and it is seen that 310 kg of carrier liquid and induced condensing agent are provided in the catalyst feed per mol catalyst.

When the combined amount of carrier liquid and any induced condensing agent in the catalyst feed is kept at or above the above-described amounts per mole of catalyst in the catalyst feed, polymer sheeting is substantially reduced in the polymerization reactor. For instance, the rate of polymer sheeting in the reactor may be ≤0.3%. In various embodiments, the polymer sheeting rate may be ≤0.3%, ≤0.27%, ≤0.25%, ≤0.23%, ≤0.2%, ≤0.17%, ≤0.15%, ≤0.13%, ≤0.1%, ≤0.09%, ≤, 0.8%, ≤0.07%, ≤0.06%, ≤0.05%, or ≤0.04%.

In some embodiments, the catalyst feed comprising the catalyst and the carrier liquid and any induced condensing agent can be introduced into the reactor through two, three, four, or more nozzles such that an average total molar catalyst flow per nozzle can be ≤0.073 mol/hr, ≤0.070 mol/hr, ≤0.067 mol/hr, ≤0.065 mol/hr, ≤0.063 mol/hr, ≤0.06 mol/hr, ≤0.057 mol/hr, or ≤0.055 mol/hr. In some embodiments, the catalyst and the carrier liquid and any induced condensing agent can be introduced into the reactor through two, three, four, or more nozzles such that the average mass flow rate of the catalyst through each nozzle can be ≤1.95 kg/hr, ≤1.90 kg/hr, ≤1.85 kg/hr, ≤1.80 kg/hr, ≤1.75 kg/hr, ≤1.70 kg/hr, ≤1.65 kg/hr, ≤1.60 kg/hr, ≤1.55 kg/hr, or ≤1.55 kg/hr. (From these average hourly flowrates of catalyst, one can readily calculate the hourly mass flow rates needed to meet the above-recited amounts of carrier liquid and any induced condensing agent on the basis of moles of catalyst or weight ratio to catalyst.)

In some embodiments, the catalyst feed may be formed from separate components combined at the reactor inlet through which catalyst is fed (e.g., catalyst may be injected into a carrier liquid just before the reactor, or vice versa, carrier liquid may be injected into the catalyst stream just before the reactor). In yet other embodiments, the catalyst feed may comprise a catalyst-containing mixture, in which catalyst and the carrier liquid can be mixed, blended, or otherwise combined with one another (optionally with any induced condensing agent) to produce one or more catalyst-containing mixtures, such that the catalyst-containing mixture(s) can be introduced into the polymerization reactor as the catalyst feed. A catalyst-containing mixture could include a catalyst slurry and/or a catalyst solution, each of which are discussed in more detail below. Further, where multiple catalyst-containing mixtures (e.g., a slurry and a solution) are produced, they can be added separately into the polymerization reactor as the catalyst feed or, preferably, pre-blended and added together into the polymerization reactor as the catalyst feed. Regardless, carrier liquid and/or induced condensing agent fed into the reactor from all sources (including all catalyst-containing mixtures and any other feed, e.g., cycle gas including induced condensing agent) are included for purposes of determining the amount of carrier liquid and induced condensing agent added to the reactor.

In some embodiments, the catalyst-containing mixture can include 1 wt %, 5 wt %, 8 wt %, or 10 wt % to 15 wt %, 20 wt %, 25 wt %, 30 wt %, 35 wt %, or 40 wt % of solids, based on a total weight of the catalyst-containing mixture. The solids include the catalyst(s), any support, any activator, and, if present, any other solid component(s). The wax, if present in the carrier liquid, is considered a liquid component and not a solid component. For example, if the catalyst-containing mixture includes a first catalyst, a second catalyst, a support, an activator, and the carrier liquid that includes a mineral oil and a wax, the solid components include the first and second catalyst, the support, and the activator; and the liquid components include the mineral oil and the wax.

In some embodiments, the amount of carrier liquid and/or induced condensing agent per mole of catalyst (e.g., the one or more catalyst compounds) introduced into the polymerization reactor in the catalyst feed can be increased by increasing the amount of carrier liquid in the catalyst-containing mixture. It should be understood, that when the amount of carrier liquid in the catalyst-containing mixture increases, the feed rate of the catalyst-containing mixture into the polymerization reactor can also be increased to maintain a desired rate of polymer production.

In at least one embodiment, the catalyst-containing mixture can include a first catalyst compound that can be a high molecular weight component and a second catalyst compound that can be a low molecular weight component. In other words, the first catalyst compound can be one that makes primarily high molecular-weight polymer chains, and the second catalyst compound makes primarily low molecular-weight polymer chains. Further, the polymer product may then comprise both the high- and low-molecular weight components. In at least one embodiment, the two catalyst compounds can be present in a catalyst pot of a reactor system, and a molar ratio of the first catalyst compound to the second catalyst compound can be from 99:1 to 1:99, 90:10 to 10:90, 85:15 to 15:85, 75:25 to 25:75, 60:40 to 40:60, 55:45 to 45:55. In some embodiments, the first catalyst compound and/or the second catalyst compound can also be added to a polymerization process as a trim catalyst to adjust the molar ratio of the first catalyst compound to the second catalyst compound. In at least one embodiment, the first catalyst compound and the second catalyst compound can each be a metallocene catalyst. Where such trim catalyst adjustments are employed, it can be seen that two or more catalyst-containing mixtures are combined to make the catalyst feed provided to the reactor.

As noted previously, the catalyst-containing mixture can be in the form of a slurry catalyst mixture. The term “slurry catalyst mixture” refers to a contact product that includes at least one catalyst compound and the carrier liquid, and optionally one or more of an activator, a co-activator, and a support. In particular embodiments, the slurry catalyst mixture may include two catalyst compounds, e.g., two metallocene catalyst compounds. For instance, the slurry catalyst mixture may include a first and a second metallocene catalyst compound (each being different from the other). See below for more description regarding dual metallocene catalyst systems particularly suitable in some embodiments of the present disclosure.

Another example of a catalyst-containing mixture is a solution catalyst mixture, which can be or can include, but is not limited to, a contact product of an activator, a diluent, and one or more catalysts. The diluent can be or can include, but is not limited to, carrier liquid (e.g., the same or a similar carrier liquid as used in the catalyst slurry, such as mineral oil). Preferably, the diluent in a solution catalyst mixture is the same as the carrier liquid used in a slurry catalyst mixture. Particular embodiments include blending two or more catalyst-containing mixtures, e.g., a slurry catalyst mixture and a solution catalyst mixture. In a particularly preferred embodiment, a slurry catalyst mixture (comprising the contact product of carrier fluid such as mineral oil, two metallocene catalyst compounds, activator(s), and support) is blended with a solution catalyst mixture (comprising one of the two metallocene catalyst compounds, activator, and carrier liquid) to form the catalyst feed provided to the polymerization reactor. Such a process may particularly be referred to as a “catalyst trim” process, and the solution catalyst mixture in such embodiments may be called a “trim solution.” Catalyst slurries and trim solutions are discussed in some additional detail further below.

In some embodiments, when the catalyst feed includes an induced condensing agent in addition to the carrier liquid, the induced condensing agent in the catalyst feed may constitute 30 to 90 wt % of the combined feed rate of carrier liquid and induced condensing agent within the catalyst feed, with the balance comprising the carrier liquid (e.g., 10 wt % to 70 wt % carrier liquid). It is also contemplated that in these and other embodiments, induced condensing agent may constitute from a low of any one of 30, 35, 40, 45, or 50 wt % of the combined feed (induced condensing agent plus carrier liquid in the catalyst feed), to a high of any one of 60, 70, 80, or 90 wt % of the combined feed. In some embodiments, when carrier liquid includes a mineral oil and a wax and the induced condensing agent is introduced into the polymerization reactor, a combined feed rate of the mineral oil, the wax, and the induced condensing agent can be broken down as follows: mineral oil may constitute from a low of 8, 15, 20, or 25 wt % to a high of 40, 50, 60, or 68 wt % of the combined feed; wax may constitute from a low of 2, 5, or 7 wt % to a high of 10, 12, or 15 wt % of the combined feed; and induced condensing agent may constitute from a low of 30, 40, 45, or 50 wt % to a high of 60, 70, 80, or 90 wt % of the combined feed, based on the combined feed rate of the mineral oil, the wax, and the induced condensing agent.

### Gas Phase Polymerization Reactor

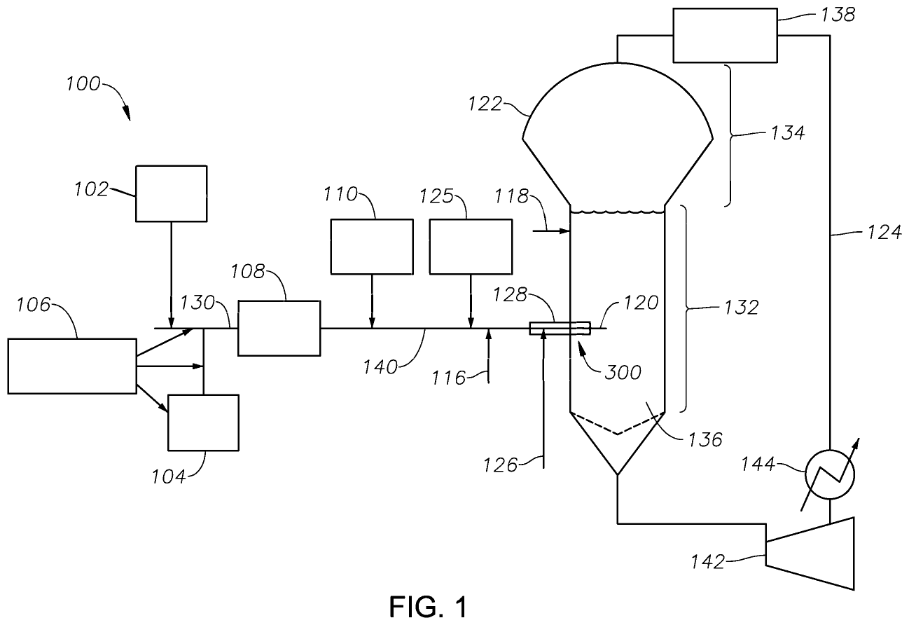

FIG. 1 is a schematic of a gas-phase reactor system 100, showing the introduction of two catalysts into a gas-phase fluidized bed polymerization reactor 122. A first catalyst-containing mixture that can include one or more catalysts and a carrier liquid can be introduced into a first vessel or catalyst pot (cat pot) 102. A second catalyst-containing mixture that can include a solvent and at least one second catalyst and/or activator can be introduced into a second vessel or trim pot 104. In some embodiments, the first mixture can be referred to as a slurry catalyst mixture and the second mixture can be referred to as a solution catalyst mixture. The first and second mixtures can be mixed, blended, or otherwise combined in line 130 and introduced into a static mixer or an agitating vessel 108 to produce a combined catalyst-containing mixture output toward the reactor 122 via line 140 as the catalyst feed (noting that, as will be discussed below, other components may be added to the catalyst feed on its way to the reactor 122). It should be understood, that while a catalyst feed that includes at least two catalysts is described, the catalyst feed can include a single catalyst or three or more catalysts. In some embodiments, the first catalyst-containing mixture (e.g., the slurry catalyst mixture noted above) can also include one or more waxes. See also FIG. 1 of WO2020/092599 and accompanying description (e.g., at Paragraphs 102-124), incorporated herein by reference.

The catalyst pot 102 can be an agitated holding tank configured to keep the solids concentration homogenous. In some embodiments, the catalyst pot 102 can be maintained at an elevated temperature, such as from 30° C., 40° C., or 43° C. to 45° C., 60° C., or 75° C. Elevated temperature can be obtained by electrically heat tracing the catalyst pot 102 using, for example, a heating blanket. Maintaining the catalyst pot 102 at an elevated temperature can further reduce or eliminate solid residue formation on vessel walls which could otherwise slide off the walls and cause plugging in downstream delivery lines. In at least one embodiment, the catalyst pot 102 can have a volume of 0.75 m³, 1.15 m³, 1.5 m³, 1.9 m³, or 2.3 m³ to 3 m³, 3.8 m³, 5.7 m³, or 7.6 m³.

The catalyst pot 102 can be maintained at a pressure of 250 kPa-absolute or greater, such as from 250 kPa-absolute, 285 kPa-absolute, or 325 kPa-absolute to 375 kPa-absolute, 450 kPa-absolute, or 515 kPa-absolute. In various embodiments, lines 130 and/or 140 of the gas-phase reactor system 100 can be maintained at an elevated temperature, such as from 30° C., 40° C., or 43° C. to 45° C., 60° C., or 75° C. An elevated temperature can be obtained by electrically heat tracing lines 130 and/or 140 using, for example, a heating blanket. Maintaining lines 130 and/or 140 at an elevated temperature can provide the same or similar benefits as described for an elevated temperature of catalyst pot 102.

The trim pot 104 can have a volume of 0.38 m³, 0.75 m³, 1.15 m³, 1.5 m³, 1.9 m³, or 2.3 m³ to 3 m³, 3.8 m³, 5.7 m³, or 7.6 m³. The trim pot 104 can be maintained at an elevated temperature, such as from 30° C., 40° C., or 43° C. to 45° C., 60° C., or 75° C. The trim pot 104 can be heated by electrically heat tracing the trim pot 104, for example, via a heating blanket. Maintaining the trim pot 104 at an elevated temperature can provide reduced or eliminated foaming within lines 130 and/or 140 when the slurry catalyst mixture from catalyst pot 102 is combined in-line (also referred to herein as “on-line”) with a solution catalyst mixture from trim pot 104.

In some embodiments, a nucleating agent 106 such as silica, alumina, fumed silica or other suitable particulate matter can be added to the first mixture and/or the second mixture in-line or in the vessels 102 or 104. Similarly, activators and/or catalyst compounds can be added in-line. For example, a second slurry catalyst mixture that includes a different catalyst can be introduced from a second cat pot (which can also include mineral oil and a wax). The two slurry catalyst mixtures can be used as the catalyst-containing mixture with or without the addition of a solution catalyst mixture from the trim pot 104.

The mixing of the first and second catalyst-containing mixtures should be sufficient to allow the catalyst compound in the solution catalyst mixture to disperse in the slurry catalyst mixture such that the catalyst component, originally in the solution, can migrate to a supported component (e.g., a supported activator) that can originally be present in the first mixture (the slurry catalyst mixture, in this example). The combination can form a uniform dispersion of catalyst compounds on the supported component. The length of time that the slurry and the solution can be contacted can be 1 minute, 5 minutes, 10 minutes, or 20 minutes to 30 minutes, 40 minutes, 60 minutes, 120 minutes, 180 minutes, or 220 minutes.

The static mixer or agitating vessel 108 can be maintained at an elevated temperature, such as from 30° C., 40° C., or 43° C. to 45° C., 60° C., or 75° C. The elevated temperature of the static mixer or agitating vessel 108 can be obtained by electrically heat tracing the static mixer 108 using, for example, a heating blanket. Maintaining the static mixer or agitating vessel 108 at an elevated temperature can provide reduced or eliminated foaming in the static mixer or the agitating vessel 108 and can promote mixing of the slurry catalyst mixture and catalyst solution (as compared to lower temperatures), which can reduce run times in the static mixer and for the overall polymerization process.

In various embodiments, an aluminum alkyl, an ethoxylated aluminum alkyl, an aluminoxane, an anti-static agent or a borate activator, such as a C₁ to C₁₅ alkyl aluminum (for example tri-isobutyl aluminum, trimethyl aluminum or the like), a C₁ to C₁₅ ethoxylated alkyl aluminum or methyl aluminoxane, ethyl aluminoxane, isobutylaluminoxane, modified aluminoxane or the like can be added in-line to the catalyst feed. For example, the alkyls, antistatic agents, borate activators and/or aluminoxanes can be added from a vessel 110 directly to the catalyst feed in line 140. The additional alkyls, antistatic agents, borate activators and/or aluminoxanes can be present in an amount of 1 ppm, 10 ppm, 50 ppm, 75 ppm, or 100 ppm to 200 ppm, 300 ppm, 400 ppm, or 500 ppm. In some embodiments, the optional carrier fluid via line 126 such as molecular nitrogen, argon, ethane, propane, and the like, can be added in-line to the catalyst feed. The carrier fluid, e.g., molecular nitrogen, can be introduced through the nozzle at a rate of (or, when multiple nozzles are used, at an average rate of) about 0.4 kg/hr, 1 kg/hr, 5 kg/hr, or 8 kg/hr to 11 kg/hr, 23 kg/hr, or 45 kg/hr per nozzle. In other embodiments, the carrier fluid can be introduced through the nozzle at a rate of or when multiple nozzles are used at an average rate of about 5 kg/hr, 7 kg/hr, 9 kg/hr, or 10 kg/hr to 11 kg/hr, 13 kg/hr, or 15 kg/hr per nozzle.

In various embodiments, one or more induced condensing agents, e.g., one or more alkanes such as propane, isobutane, isopentane, isohexane, or a mixture thereof (or any other known induced condensing agent), can be added to the catalyst feed in line 140 via a vessel 112. Such induced condensing agent would be provided to the reactor 122 in addition to any separate induced condensing agent provided, e.g., through cycle gas line 124 via compressor 142. As noted previously, for purposes of determining combined amount of carrier liquid and induced condensing agent per mol catalyst, only the induced condensing agent included in the catalyst feed 140 (e.g., via vessel 112 in the example of FIG. 1) is counted. In some embodiments, one or more monomers via line 116, such as ethylene, hexene, another alpha-olefin, a diolefin, or a mixture thereof, can be added in-line to the catalyst-containing mixture. In some embodiments, the one or more monomers can be introduced into the reactor separate and apart from the catalyst-containing mixture (e.g., via line 118 or otherwise). In some embodiments, the induced condensing agent can be introduced through the nozzle at a rate of or when multiple nozzles are used at an average rate of about 0.4 kg/hr, 1 kg/hr, 5 kg/hr, or 8 kg/hr to 11 kg/hr, 23 kg/hr, or 45 kg/hr per nozzle. In some embodiments, the induced condensing agent can be introduced through the nozzle at a rate of or when multiple nozzles are used at an average rate of about 5 kg/hr, 9 kg/hr, 11 kg/hr, or 13 kg/hr to 17 kg/hr, 20 kg/hr, or 23 kg/hr per nozzle.

In some embodiments, a carrier fluid, such as molecular nitrogen, monomer, or other materials can be introduced (e.g., via line 126 as shown in FIG. 1) to the catalyst feed. This can take place along line 140, or, as shown in FIG. 1, at an injection nozzle 300, which can include a support tube 128 that can at least partially surround an injection tube 120. The catalyst feed can be passed through the injection tube 120 into the reactor 122. In various embodiments, the injection tube 120 can aerosolize the catalyst-containing mixture. Any number of suitable tubing sizes and configurations can be used to aerosolize and/or inject the slurry/solution mixture.

In some configurations (not shown in FIG. 1), the carrier fluid may be split off or otherwise sourced, directly or indirectly, from cycle gas 124 (e.g., all or a portion of the cycle gas 124). In this case, where cycle gas is used as a carrier fluid, the skilled artisan might appreciate that such cycle gas could include induced condensing agent. Where cycle gas is used as all or part of an optional carrier fluid that is added to catalyst feed (either at or upstream of the nozzle 300), then in that case, any carrier liquid or induced condensing agent in the cycle gas that is so added to and intermingled with the catalyst feed, should be counted as carrier liquid or induced condensing agent in the catalyst feed (i.e., such carrier liquid or induced condensing agent would count toward the total amount of carrier liquid plus induced condensing agent per amount of catalyst for purposes of the present disclosure). Put simply, the amount of carrier liquid and induced condensing agent per amount (moles or weight) of catalyst is calculated on the basis of such components being fed to the reactor in a manner such that the components intermingle with the catalyst before being fed to the reactor (whether intermingling takes place in the nozzle itself, or upstream of the nozzle). However, as will be noted below, nozzles according to some embodiments may include multiple channels that enable separate feeds into the reactor; where components are fed through separate channels in the nozzle such that they do not intermingle with the catalyst prior to entering the reactor, then those components would not count toward the total carrier liquid plus induced condensing agent calculations.

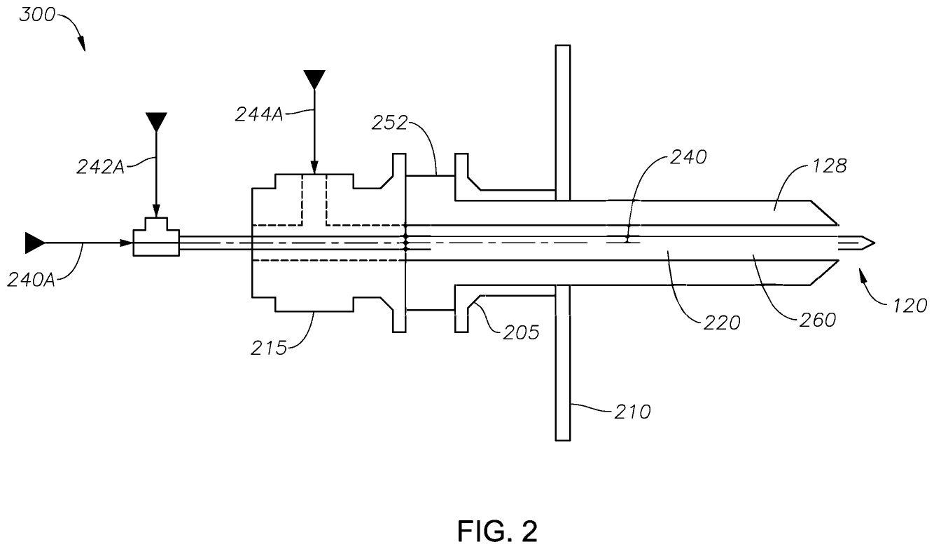

Returning to the nozzle 300, as shown in FIG. 2, the nozzle 300 can be an “effervescent” nozzle in various embodiments. This could provide a 3-fold increase (or more) in nozzle efficiency of a trim process as compared to conventional trim process nozzles. As shown in FIG. 2, nozzle 300 can be in fluid communication with one or more feed lines (three are shown in FIG. 2) 240A, 242A, 244A. Each feed line 240A, 242A, 244A can provide a flow path for one or more monomers, induced condensing agents, carrier fluids (e.g., molecular nitrogen, argon, ethane, propane, and the like), and/or catalyst feed to any one or more of a first conduit 220, a second conduit 240, and/or a support member or support tube 128. In some embodiments, feed line 242A can provide the catalyst feed from stream 140 (shown in FIG. 1), feed line 240A can provide the carrier fluid from line 126 and/or recycle gas from line 124 (or a portion thereof), and feed line 244A can provide the one or more olefins (eg., from line 116) and optionally the one or more induced condensing agents from line 112. Alternatively, feed lines 240A, 242A, and 244A can independently introduce the carrier fluid, the catalyst feed, and the one or more olefins into the reactor 122 (that is, not through the nozzle).

Feed line 240A can be in fluid communication with the innermost conduit 240. In addition, feed line 242A can be in fluid communication with an intermediate feed conduit 220 surrounding 240 (that is, the fed conduit 220 can be considered as the annulus defined by an outer surface of the second conduit 240 and an inner surface of the first conduit 220). Furthermore, in some embodiments (as shown in FIG. 2), the innermost conduit 240 can include perforations at any point or points along the outer surface of the conduit 240 (e.g., along the entire conduit, or along the conduit at a distal end near the reactor, etc.). The perforations allow for intermingling of the fluid fed through innermost conduit 240 and fluid fed through intermediate conduit 220 prior to discharge into the reactor. Finally, feed line 244A can be in fluid communication with an annulus 260 defined by the inner surface of the support member 128 and the outer surface of the first conduit 220. This annulus 260 in various embodiments (such as those in accordance with the nozzle 300 of FIG. 2) does not enable intermingling of fluids in the annulus 260 with fluids in the intermediate conduit 220 and/or innermost conduit 240.

In some embodiments, the catalyst feed can be injected into the intermediate conduit 220 using the feed line 242A (“catalyst feed line”). The one or more carrier fluids or inert gases can be injected into the innermost conduit 240 using the feed line 240A (“purge gas feed line”). In embodiments wherein the innermost conduit 240 includes perforations, such as discussed above, the catalyst feed fed through catalyst feed line 242A and carrier fluids or inert gases fed through purge gas feed line 240A are therefore intermingled in the nozzle. Further, the one or more monomers can be injected into the annulus 260 using the feed line 244A (“monomer feed line”). The feed lines 240A, 242A, 244A can be any conduit capable of transporting a fluid therein. Suitable conduits can include tubing, flex hose, and pipe. In some embodiments, a three-way valve 215 can be used to introduce and control the flow of the fluids (e.g., catalyst-containing mixture, carrier fluid, and monomer) to the injection nozzle 300. Any suitable commercially available three-way valve can be used.

In some embodiments, a total amount of the olefin(s) or monomer(s) introduced into the reactor 205 can be at a flow rate of 40 kg/hr per cubic meter of polymerization reactor volume, 50 kg/hr per cubic meter of polymerization reactor volume, 60 kg/hr per cubic meter of polymerization reactor volume, or 70 kg/hr per cubic meter of polymerization reactor volume to 90 kg/hr per cubic meter of polymerization reactor volume, 100 kg/hr per cubic meter of polymerization reactor volume, 110 kg/hr per cubic meter of polymerization reactor volume, or 125 kg/hr per cubic meter of polymerization reactor volume.

In some embodiments, the catalyst feed can include 1 wt %, 5 wt %, 10 wt %, or 15 wt % to 25 wt %, 30 wt %, 35 wt %, or 40 wt % of the one more catalysts, based on a total weight of the catalyst feed. In such embodiments, a total amount of the catalyst feed introduced into the reactor 122 can be at a flow rate of ≥0.1 kg/hr per cubic meter of polymerization reactor volume, ≥0.11 kg/hr per cubic meter of polymerization reactor volume, ≥0.12 kg/hr per cubic meter of polymerization reactor volume, 0.13 kg/hr per cubic meter of polymerization reactor volume or ≥0.14 kg/hr per cubic meter of polymerization reactor volume to 0.2 kg/hr per cubic meter of polymerization reactor volume, 0.3 kg/hr per cubic meter of polymerization reactor volume, 0.4 kg/hr per cubic meter of polymerization reactor volume, or 0.5 kg/hr per cubic meter of polymerization reactor volume.

Support member 128 can include a first end having a flanged section 252. The support member 128 can also include a second end that is open to allow a fluid to flow therethrough. In one or more embodiments, support member 128 can be secured to a reactor wall 210. In one or more embodiments, flanged section 252 can be adapted to mate or abut up against a flanged portion 205 of the reactor wall 210 as shown.

In some embodiments, at least a portion of the support tube 128 can have a tapered outer diameter. The second end (“open end”) of support tube 128 can be tapered to reduce the wall thickness at the tip of the support tube 128 protruding into the reactor. Reducing or minimizing the area at the tip of support tube 128 can help reduce or prevent fouling. Fouling can be caused due to agglomerate formation of polymer on a nozzle, a concept referred to as “pineappling”. A suitable effervescent nozzle for at least one embodiment of the present disclosure can include the nozzle described in U.S. Patent Pub. No. 2010/0041841 A1.

As shown in FIG. 2, support member 128 can be a tubular or annular member. Support member 128 can have an inner diameter large enough to surround the first conduit 220. In some embodiments, the monomer flow through the nozzle 300 or when multiple nozzles 300 are used an average monomer flow introduced into the reactor 122 can be from 50 kg/hr, 500 kg/hr, 1,000 kg/hr, 3,500 kg/hr, 5,000 kg/hr, 7,500 kg/hr, 10,000 kg/hr, or 12,000 kg/hr to 15,000 kg/hr, 20,000 kg/hr, 30,000 kg/hr, 40,000 kg/hr, 60,000 kg/hr, or 80,000 kg/hr or more. In other embodiments, the monomer flow through the nozzle 300 or when multiple nozzles 300 are used an average monomer flow introduced into the reactor 122 can be from 50 kg/hr, 500 kg/hr, 1,000 kg/hr, 1,500 kg/hr, 2,000 kg/hr, 2,500 kg/hr, 3,000 kg/hr, or 4,000 kg/hr to 5,000 kg/hr, 7,000 kg/hr, 8,500 kg/hr, 10,000 kg/hr, 11,000 kg/hr, or 12,500 kg/hr or more. It should be understood that the monomer flow through the nozzle can include a fresh monomer feed being introduced into the reactor 122 and monomer can also be introduced through the nozzle as a component of the recycle gas that also includes the carrier fluid.

The nozzle 300 can further provide control of the catalyst feed droplet size introduced into the reactor 122 as a function of gas velocity and not liquid velocity, which allows a desired droplet size to be achieved by adjusting, for example, the carrier fluid flow rate (e.g., 126 of FIG. 1) while allowing a range of induced condensing agent (e.g., 112 of FIG. 1) to be utilized during a polymerization process. For example, in at least one embodiment, a ratio of supported catalyst particles per droplet of liquid carrier can be from 1:1 to 10:1, such as 5:1, which can provide reduced overall amounts of carrier liquid plus ICA (such as isopentane (iC5)) used during a trim polymerization process, as compared to a conventional trim catalyst particle to droplet ratio of 1:1. In some embodiments, the average droplet size of the catalyst feed introduced into the reactor can be ≤122 μm, ≤121 μm, ≤120 μm, ≤119 μm, ≤118 μm, ≤117 μm, or ≤116 μm. In some embodiments, each droplet can include an average of ≤1.8 catalyst particles per droplet, ≤1.7 catalyst particles per droplet, ≤1.6 catalyst particles per droplet, or ≤1.5 catalyst particles per droplet.

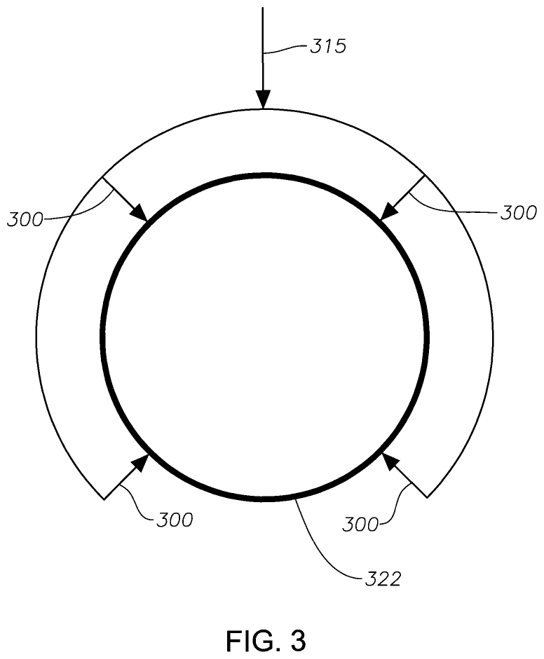

FIG. 3 depicts a top-down cross-sectional view of an illustrative gas-phase reactor 322 that includes a plurality of the nozzles 300 shown in FIG. 2, according to one or more embodiments. In some embodiments, two or more nozzles 300 (four are shown in FIG. 3) can be coupled to the reactor 322, and the flow rate of the catalyst feed can be less than if only one effervescent nozzle was coupled with the reactor 322. In some embodiments, three nozzles 300 can be used to introduce catalyst feed into the reactor 322. In some embodiments, in a first polymerization process in which the reactor 322 includes three nozzles 300, an average flow rate of the catalyst feed through each of the three nozzles 300 can be at least 10%, at least 12%, at least 15%, at least 17%, at least 20%, at least 23%, at least 25%, at least 27%, at least 30%, at least 33%, or at least 35% less than an average flow rate of the catalyst feed through each of only two nozzles in a second polymerization process, where the amount of polymer product produced per hour in the first and second polymerization process are the same. In some embodiments, the nozzles 300 can be at a same reactor elevation with respect to one another, at different reactor elevations with respect to one another, or two or more nozzles 300 can be at a same reactor elevation with respect to one another and at least one nozzle 300 can be at a different reactor elevation with respect to the two or more nozzles 300.

In some embodiments, one or more additional nozzles 300 (e.g., a fourth nozzle) can also be coupled to the reactor 322 and can remain inactive (e.g., offline) until one of the first three nozzles becomes inactive. In one embodiment, each effervescent nozzle 300 (e.g., all four nozzles) can be active (e.g., online) during a polymerization process. It should be understood that the catalyst feed can be introduced via line 315 into each nozzle 300 and that the catalyst feed can be the same or similar to the catalyst feed in line 140, as discussed above with reference to FIG. 1. It should also be understood that the additional feed lines that can introduce the carrier fluid, e.g., reactor overhead recycle, the olefin, etc. are left out for simplification. As such, all feeds fed into the nozzle 300 can be represented via line 315. In some embodiments, the catalyst feed can be introduced into the nozzles 300 via a catalyst flow splitter. A suitable catalyst flow splitter can include the one described in U.S. Pat. No. 7,980,264.

Returning to FIG. 1, in some embodiments, to promote formation of particles in the reactor 122, a nucleating agent 118, such as fumed silica, can be added directly into the reactor 122. Conventional trim polymerization processes include introducing a nucleating agent into the polymerization reactor 122. However, processes of the present disclosure have provided advantages such that the addition of a nucleating agent (such as spray dried fumed silica) into the reactor can be optional. For embodiments that do not include a nucleating agent, it has been discovered that a high polymer bulk density (e.g., 0.4 g/cm³ or greater) can be obtained, which is greater than the bulk density of polymers formed by conventional trim processes. Furthermore, when a metallocene catalyst or other similar catalyst is used in the gas phase reactor, oxygen or fluorobenzene can be added to the reactor 122 directly or to the gas stream (including carrier fluid) in line 126 to control the polymerization rate. Thus, when a metallocene catalyst (which is sensitive to oxygen or fluorobenzene) is used in combination with another catalyst (that is not sensitive to oxygen) in a gas phase reactor, oxygen can be used to modify the metallocene polymerization rate relative to the polymerization rate of the other catalyst. WO 1996/009328 discloses the addition of water or carbon dioxide to gas phase polymerization reactors, for example, for similar purposes.

The example above is not limiting, as additional solution catalyst mixtures and/or slurry catalyst mixtures can be used. For example, a slurry catalyst mixture can be combined with two or more solution catalyst mixtures having the same or different catalyst compounds and/or activators. Likewise, the solution catalyst mixture can be combined with two or more slurry catalyst mixtures each having the same or different supports, and the same or different catalyst compounds and/or activators. Similarly, two or more slurry catalyst mixtures can be combined with two or more solution catalyst mixtures, for example in-line, where the slurry catalyst mixtures each include the same or different supports and can include the same or different catalyst compounds and/or activators and the solution catalyst mixtures can include the same or different catalyst compounds and/or activators. For example, the slurry catalyst mixture can contain a supported activator and two different catalyst compounds, and two solution catalyst mixtures, each containing one of the catalysts in the slurry, and each can be independently combined, in-line, with the slurry.

Continuing with reference to FIG. 1, the fluidized bed reactor 122 can include a reaction zone 132 and a velocity reduction zone 134. The reaction zone 132 can include a bed 136 that can include growing polymer particles, formed polymer particles and a minor amount of catalyst particles fluidized by the continuous flow of the gaseous monomer and diluent to remove the heat of polymerization through the reaction zone 132. Optionally, some of the re-circulated gases 124 can be cooled and compressed to form liquids (e.g., where the gases include induced condensing agents), that can increase the heat removal capacity of the circulating gas stream when readmitted to the reaction zone 132. A suitable rate of gas flow can be readily determined by experimentation well within the ordinary skill. Make-up of gaseous monomer to the circulating gas stream can be at a rate equal to the rate at which particulate polymer product and monomer associated therewith is withdrawn from the reactor and the composition of the gas passing through the reactor can be adjusted to maintain an essentially steady state gaseous composition within the reaction zone 132. The gas leaving the reaction zone 132 can be passed to the velocity reduction zone 134 where entrained particles can be removed, for example, by slowing and falling back to the reaction zone 132. If desired, finer entrained particles and dust can be removed in a separation system 138. Such as a cyclone and/or fines filter. The gas 124 can be passed through a heat exchanger 144 where at least a portion of the heat of polymerization can be removed. The gas can then be compressed in a compressor 242 and returned to the reaction zone 132. Additional reactor details and processes for operating same can include those disclosed in, for example, U.S. Pat. Nos. 3,709,853; 4,003,712; 4,011,382; 4,302,566; 4,543,399; 4,882,400; 5,352,749; and 5,541,270; EP 0802202; and Belgian Patent No. 839,380.

### Catalyst

The catalyst or catalyst compounds can be or can include, but are not limited to, one or more metallocene catalyst compounds. In some embodiments, the catalyst can include at least a first metallocene catalyst compound and a second metallocene catalyst compound, where the first and second metallocene catalyst compounds have different chemical structures from one another. Metallocene catalyst compounds can include catalyst compounds having one or more Cp ligands (cyclopentadienyl and ligands isolobal to cyclopentadienyl) bound to at least one Group 3 to Group 12 metal atom, and one or more leaving group(s) bound to the at least one metal atom.

According to some embodiments, any of the metallocene catalysts as described in Paragraphs [0065]-[0081] of WO 2020/092599, which description is incorporated herein by reference. Also suitable are catalyst systems employing a mix of two metallocene catalysts such as those described in US2020/0071437, and in particular a mix of (1) a bis-cyclopentadienyl hafnocene and (2) a zirconocene, such as an indenyl-cyclopentadienyl zirconocene.

More particularly, the bis-cyclopentadienyl hafnocene may be in accordance with one or more of the metallocene catalyst compounds according to formulas (A1) and/or (A2) as described in US2020/0071437: for instance, those per formula (A1) as described in Paragraphs [0069]-[0086] of US2020/0071437; or those per formula (A2) as described in Paragraphs [0086]-[0101] of US2020/0071437, which descriptions are incorporated herein by reference.

Particular examples of hafnocenes according to formula (A1) include bis(n-propylcyclopentadienyl)hafnium dichloride, bis(n-propylcyclopentadienyl)hafnium dimethyl, (n-propylcyclopentadienyl, pentamethylcyclopentadienyl)hafnium dichloride, (n-propyl cy clopentadienyl, pentamethylcyclopentadienyl)hafnium dimethyl, (n-propylcyclopentadienyl, tetramethylcyclopentadienyl)hafnium dichloride, (n-propylcyclopentadienyl, tetramethylcyclopentadienyl)hafnium dimethyl, bis(cyclopentadienyl)hafnium dimethyl, bis(n-butylcyclopentadienyl)hafnium dichloride, bis(n-butylcyclopentadienyl)hafnium dimethyl, and bis(1-methyl-3-n-butylcyclopentadienyl)hafnium dimethyl.

Hafnocene compounds according to (A2) that are particularly useful include one or more of the compounds listed in Paragraph [0101] of US2020/0071437, also incorporated by reference herein, such as (for a relatively brief example): rac/me so Me₂Si(Me₃SiCH₂Cp)₂HfMe₂; racMe₂Si(Me₃SiCH₂Cp)₂HfMe₂; rac/meso Ph₂Si(Me₃SiCH₂Cp)₂HfMe₂; rac/meso (CH₂)₃Si(Me₃SiCH₂Cp)₂HfMe₂; rac/meso (CH₂)₄Si(Me₃SiCH₂Cp)₂HfMe₂; rac/meso (C₆F₅)₂Si(Me₃SiCH₂Cp)₂HfMe₂; rac/meso (CH₂)₃Si(Me₃SiCH₂Cp)₂ZrMe₂; rac/meso Me₂Ge(Me₃SiCH₂Cp)₂HfMe₂; rac/meso Me₂Si(Me₂PhSiCH₂Cp)₂HfMe₂; rac/meso Ph₂Si(Me₂PhSiCH₂Cp)₂HfMe₂; Me₂Si(Me₄Cp)(Me₂PhSiCH₂Cp)HfMe₂; etc.

As noted above, suitable catalyst compounds also or instead may include a zirconocene, such as a zirconocene according to formula (B) as described in Paragraphs [0103]-[0113] of US2020/0071437, which description is also incorporated herein by reference, and in particular suitable zirconocenes may be any one or more of those listed in Paragraph [0112] of US2020/0071437, e.g.: bis(indenyl)zirconium dichloride, bis(indenyl)zirconium dimethyl, bis(tetrahydro-1-indenyl)zirconium dichloride, bis(tetrahydro-1-indenyl)zirconium dimethyl, rac/meso-bis(1-ethylindenyl)zirconium dichloride, rac/meso-bis(1-ethylindenyl)zirconium dimethyl, rac/meso-bis(1-methylindenyl)zirconium dichloride, rac/meso-bis(1-methylindenyl)zirconium dimethyl, rac/meso-bis(1-propylindenyl)zirconium dichloride, rac/meso-bis(1-propylindenyl)zirconium dimethyl, rac/meso-bis(1-butylindenyl)zirconium dichloride, rac/meso-bis(1-butylindenyl)zirconium dimethyl, meso-bis(1 ethylindenyl) zirconium dichloride, meso-bis(1-ethylindenyl) zirconium dimethyl, (1-methylindenyl)(pentamethyl cyclopentadienyl) zirconium dichloride, (1-methylindenyl)(pentamethyl cyclopentadienyl) zirconium dimethyl, or combinations thereof.

### Slurry Catalyst Mixture Including Activators and Supports

As noted above, the slurry catalyst mixture can include one or more activators and/or supports in addition to one or more catalysts. The term “activator” refers to any compound or combination of compounds, supported or unsupported, which can activate a single site catalyst compound or component, such as by creating a cationic species of the catalyst component. For example, this can include the abstraction of at least one leaving group (the ‘X’ group in the single site catalyst compounds described herein) from the metal center of the single site catalyst compound/component. The activator may also be referred to as a “co-catalyst’. For example, the slurry catalyst mixture can include two or more activators (such as alumoxane and a modified alumoxane) and a catalyst compound, or the slurry catalyst mixture can include a supported activator and more than one catalyst compound. In particular embodiments, the slurry catalyst mixture can include at least one support, at least one activator, and at least two catalyst compounds. For example, the slurry can include at least one support, at least one activator, and two different catalyst compounds that can be added separately or in combination to produce the slurry catalyst mixture. In some embodiments, a mixture of a support, e.g., silica, and an activator, e.g., alumoxane, can be contacted with a catalyst compound, allowed to react, and thereafter the mixture can be contacted with another catalyst compound, for example, in a trim system.

The molar ratio of metal in the activator to metal in the catalyst compound in the slurry catalyst mixture can be 1000:1 to 0.5:1, 300:1 to 1:1, 100:1 to 1:1, or 150:1 to 1:1. The slurry catalyst mixture can include a support material which can be any inert particulate carrier material known in the art, including, but not limited to, silica, fumed silica, alumina, clay, talc or other support materials such as disclosed above. In one embodiment, the slurry can include silica and an activator, such as methyl alumoxane (“MAO”), modified methyl alumoxane (“MMAO”). Preferred activators typically include alumoxane compounds, modified alumoxane compounds, and ionizing anion precursor compounds that abstract a reactive, σ-bound, metal ligand making the metal compound cationic and providing a charge-balancing non-coordinating or weakly coordinating anion. For instance, suitable activators include any of the alumoxane activators and/or ionizing/non-coordinating anion activators described in Paragraphs [0118]-[0128] of US2020/0071437, also incorporated herein by reference.

Suitable supports include, but are not limited to, active and inactive materials, synthetic or naturally occurring zeolites, as well as inorganic materials such as clays and/or oxides such as silica, alumina, zirconia, titania, silica-alumina, cerium oxide, magnesium oxide, or combinations thereof. In particular, the support may be silica-alumina, alumina and/or a zeolite, particularly alumina. Silica-alumina may be either naturally occurring or in the form of gelatinous precipitates or gels including mixtures of silica and metal oxides. Suitable supports may include any of the support materials described in Paragraphs [0129]-[0131] of US2020/0071437, which description is also incorporated by reference herein; wherein Al₂O₃, ZrO₂, SiO₂ and combinations thereof are particularly noted.

### Waxes

In some embodiments, a catalyst-containing mixture (and in particular a catalyst slurry or a catalyst solution, or both) can also include one or more waxes. The wax, if present, can increase the viscosity of the catalyst-containing mixture. As used herein, the term “wax” includes a petrolatum also known as petroleum jelly or petroleum wax. Petroleum waxes include paraffin waxes and microcrystalline waxes, which include slack wax and scale wax. Commercially available waxes include SONO JELL® paraffin waxes, such as SONO JELL® 4 and SONO JELL® 9, available from Sonneborn, LLC. In at least one embodiment, the wax, if present, can have a density (at 100° C.) of 0.7 g/cm³, 0.73 g/cm³, or 0.75 g/cm³ to 0.87 g/cm³, 0.9 g/cm³, or 0.95 g/cm³. The wax, if present, can have a kinematic viscosity at 100° C. of 5 cSt, 10 cSt, or 15 cSt to 25 cSt, 30 cSt, or 35 cSt. The wax, if present, can have a melting point of 25° C., 35° C., or 50° C. to 80° C., 90° C., or 100° C. The wax, if present can have a boiling point of 200° C. or greater, 225° C. or greater, or 250° C. or greater.

It should be understood that the term “wax” also refers to or otherwise includes any wax not considered a petroleum wax, which include animal waxes, vegetable waxes, mineral fossil or earth waxes, ethylenic polymers and polyol ether-esters, chlorinated naphthalenes, and hydrocarbon type waxes. Animal waxes can include beeswax, lanolin, shellac wax, and Chinese insect wax. Vegetable waxes can include carnauba, candelilla, bayberry, and sugarcane. Fossil or earth waxes can include ozocerite, ceresin, and montan. Ethylenic polymers and polyol ether-esters include polyethylene glycols and methoxypolyethylene glycols. The hydrocarbon type waxes include waxes produced via Fischer-Tropsch synthesis.

In some embodiments, a catalyst-containing mixture can be free of any wax having a melting point of ≥25° C., based on a total weight of the slurry catalyst mixture. In other embodiments, the slurry catalyst mixture can include ≤3 wt %, ≤2.5 wt %, ≤2 wt %, ≤1.5 wt %, ≤1 wt %, ≤0.9 wt %, ≤0.8 wt %, ≤0.7 wt %, ≤0.6 wt %, ≤0.5 wt %, ≤0.4 wt %, ≤0.3 wt %, ≤0.2 wt %, or ≤0.1 wt % of any wax having a melting point of ≥25° C., based on a total weight of the slurry catalyst mixture. Likewise, a catalyst feed (composed of one or more slurry catalyst mixtures) can have the same amounts of any wax having a melting point of ≥25° C.

### Solution Catalyst Mixture (the “Trim Solution”)

The solution catalyst mixture can include a solvent or diluent and only catalyst compound(s), such as a metallocene, or can also include an activator. In some embodiments, the solution catalyst mixture can be or can include, but is not limited to, a contact product of the diluent and the first catalyst or the second catalyst. In some embodiments, the solution catalyst mixture can be introduced into the gas phase polymerization reactor. In at least one embodiment, the catalyst compound(s) in the solution catalyst mixture can be unsupported.

The solution catalyst mixture, if used, can be prepared by dissolving the catalyst compound and optional activators in the diluent. In some embodiments, the diluent can be an alkane, such as a C₅ to C₃₀ alkane, or a C₅ to C₁₀ alkane. Cyclic alkanes such as cyclohexane and aromatic compounds such as toluene can also be used. Mineral oil can be also used as the diluent alternatively or in addition to other alkanes such as one or more C₅ to C₃₀ alkanes. The mineral oil in the solution catalyst mixture, if used, can have the same properties as the mineral oil that can be used to make the slurry catalyst mixture described above. The diluent employed can be liquid under the conditions of polymerization and relatively inert. In one embodiment, the diluent utilized in the solution catalyst mixture can be different from the diluent used in the slurry catalyst mixture. In another embodiment, the solvent utilized in the solution catalyst mixture can be the same as the diluent, i.e., the mineral oil(s) and any additional diluents used in the slurry catalyst mixture.

If the solution catalyst mixture includes both the catalyst and an activator, the ratio of metal in the activator to metal in the catalyst in the solution catalyst mixture can be 1000:1 to 0.5:1, 300:1 to 1:1, or 150:1 to 1:1. In various embodiments, the activator and catalyst can be present in the solution catalyst mixture at up to about 90 wt %, at up to about 50 wt %, at up to about 20 wt %, such as at up to about 10 wt %, at up to about 5 wt %, at less than 1 wt %, or between 100 ppm and 1 wt %, based on the weight of the diluent, the activator, and the catalyst. The one or more activators in the solution catalyst mixture, if used, can be the same or different as the one or more activators used in the slurry catalyst mixture.

The solution catalyst mixture can include any one or more of the catalyst compound(s) of the present disclosure. As the catalyst is dissolved in the diluent, a higher solubility can be desirable. Accordingly, the catalyst in the solution catalyst mixture can often include a metallocene, which may have higher solubility than other catalysts. In the polymerization processes described herein, any solution catalyst mixture can be combined with any of the slurry catalyst mixtures described herein. In addition, more than one solution catalyst mixture can be utilized.

### Continuity Additive/Static Control Agent

In gas-phase polyethylene production processes, it can be desirable to use one or more static control agents to help facilitate the regulation of static levels within the reactor. The continuity additive is a chemical composition that, when introduced into the fluidized bed within the reactor, can influence or drive static charge (negative, positive, or to zero) in the fluidized bed. The continuity additive used can depend, at least in part, on the nature of the static charge, and the choice of static control agent can vary depending, at least in part, on the polymer being produced and/or the single site catalyst compounds being used. In some embodiments, the continuity additive or static control agent can be introduced into the reactor in an amount of about 0.05 ppm, about 2 ppm, about 5 ppm, about 10 ppm, or about 20 ppm to about 50 ppm, about 75 ppm, about 100 ppm, about 150 ppm, or about 200 ppm.

In some embodiments, the continuity additive can be or can include aluminum stearate. The continuity additive can be selected for its ability to receive the static charge in the fluidized bed without adversely affecting productivity. Other suitable continuity additives can be or can include, but are not limited to, aluminum distearate, ethoxylated amines, and anti-static compositions such as those provided by Innospec Inc. under the trade name OCTASTAT. For example, OCTASTAT 2000 is a mixture of a polysulfone copolymer, a polymeric polyamine, and oil soluble sulfonic acid. Any of the continuity additives can be used either alone or in combination.

In some embodiments, the continuity additive can include fatty acid amines, amide-hydrocarbon or ethyoxylated-amide compounds such as those described as “surface modifiers” in WO Publication No. 96/11961; carboxylate compounds such as aryl-carboxylates and long chain hydrocarbon carboxylates, and fatty acid-metal complexes; alcohols, ethers, sulfate compounds, metal oxides and other compounds known in the art. Some specific examples of control agents can be or can include, but are not limited to, 1,2-diether organic compounds, magnesium oxide, ARMOSTAT® 310, ATMER® 163, ATMER® AS-990, and other glycerol esters, ethoxylated amines (e.g., N,N-bis(2-hydroxyethyl)octadecylamine), alkyl sulfonates, and alkoxylated fatty acid esters; STADIS 450 and 425, KEROSTAT CE 4009 and KEROSTAT CE 5009. chromium N-oleylanthranilate salts, calcium salts of a Medialan acid and di-tert-butylphenol; an α-olefin-acrylonitrile copolymer and polymeric polyamine, EDENOL® D32, sorbitan-monooleate, glycerol monostearate, methyl toluate, dimethyl maleate, dimethyl fumarate, triethylamine, 3,3-diphenyl-3-(imidazol-1-yl)-propin, and like compounds. In some embodiments, another continuity additive can include a metal carboxylate salt, optionally, with other compounds.

In some embodiments, the continuity additive can include an extracted metal carboxylate salt can be combined with an amine containing agent (e.g., an extracted carboxylate metal salt with any family member belonging to the KEMAMINE® (available from PMC Biogenix, Inc.) or ATMER (available from Croda). For example, the extracted metal carboxylate salt can be combined with antistatic agents such as fatty amines, such as, KEMAMINE® AS 990/2 zinc additive, a blend of ethoxylated stearyl amine and zinc stearate, or KEMAMINE® AS 990/3, a blend of ethoxylated stearyl amine, zinc stearate and octadecyl-3,5-di-tert-butyl-4-hydroxyhydrocinnamate.

Other continuity additives can include ethyleneimine additives such as polyethyleneimines having the following general formula: —(CH₂—CH₂—NH)n-, where n can be from about 10 to about 10,000. The polyethyleneimines can be linear, branched, or hyper branched (e.g., forming dendritic or arborescent polymer structures). The polyethyleneimines can be a homopolymer or copolymer of ethyleneimine or mixtures thereof (referred to as polyethyleneimine(s) hereafter). Although linear polymers represented by the chemical formula —(CH₂—CH₂—NH)n- can be used as the polyethyleneimine, materials having primary, secondary, and tertiary branches can also be used. Commercial polyethyleneimine can be a compound having branches of the ethyleneimine polymer.

### Induced Condensing Agent

In some embodiments, one or more induced condensing agents can be introduced into the reactor that can increase the production rate of polymer product. The induced condensing agent can be condensable under the conditions within the polymerization reactor. The introduction of an induced condensing agent into the reactor is often referred to as operating the reactor in “condensed mode.” The induced condensing agent can be non-reactive in the polymerization process, but the presence of the induced condensing agent can increase the production rate of the polymer product. In some embodiments, the induced condensing agent can be or can include, but is not limited to, one or more alkanes. Illustrative alkanes can be or can include, but are not limited to, propane, n-butane, isobutane, n-pentane, isopentane, neopentane, n-hexane, isohexane, n-heptane, n-octane, or any mixture thereof. Further details on induced condensing agents can be found in U.S. Pat. Nos. 5,352,749; 5,405,922; 5,436, 304; and 7,122,607; and PCT Patent Application Publication Number WO 2005/113615(A2).

### Polymerization

The temperature within the reaction zone 132 can be greater than 30° C., greater than 40° C., greater than 50° C., greater than 90° C., greater than 100° C., greater than 110° C., greater than 120° C., greater than 150° C., or higher. In general, the reactor 122 can be operated at a suitable temperature taking into account the sintering temperature of the polymer product being produced within the reactor 122. Thus, the upper temperature limit in one embodiment can be the melting temperature of the polymer product produced within in the reactor 122. However, higher temperatures can result in narrower molecular weight distributions that can be improved by the addition of a catalyst, or other co-catalysts.

In some embodiments, hydrogen gas can be used in the polymerization process to help control or otherwise adjust the final properties of the polyolefin, such as described in the “Polypropylene Handbook, at pages 76-78 (Hamer Publishers, 1996). Using certain catalyst systems, increasing concentrations (partial pressures) of hydrogen can increase a flow index such as the melt index of the polyethylene polymer. The melt index can thus be influenced by the hydrogen concentration. The amount of hydrogen in the polymerization can be expressed as a mole ratio relative to the total polymerizable monomer, for example, ethylene, or a blend of ethylene and hexene or propylene.

The amount of hydrogen used in the polymerization process can be an amount necessary to achieve the desired melt index of the final polyolefin polymer. For example, the mole ratio of hydrogen to total monomer (H₂:monomer) can be 0.0001 or greater, 0.0005 or greater, or 0.001 or greater. Further, the mole ratio of hydrogen to total monomer (H₂:monomer) can be 10 or less, 5 or less, 3 or less, or 0.10 or less. A range for the mole ratio of hydrogen to monomer can include any combination of any upper mole ratio limit with any lower mole ratio limit described herein. The amount of hydrogen in the reactor at any time can range to up to 5,000 ppm, up to 4,000 ppm in another embodiment, up to 3,000 ppm, or from 50 ppm to 5,000 ppm, or from 50 ppm to 2,000 ppm in another embodiment. The amount of hydrogen in the reactor can be from 1 ppm, 50 ppm, or 100 ppm to 400 ppm, 800 ppm, 1,000 ppm, 1,500 ppm, or 2,000 ppm, based on weight. Further, the ratio of hydrogen to total monomer (H₂:monomer) can be 0.00001:1 to 2:1, 0.005:1 to 1.5:1, or 0.0001:1 to 1:1. The one or more reactor pressures in a gas phase process (either single stage or two or more stages) can vary from 690 kPa, 1,379 kPa, or 1,724 kPa to 2,414 kPa, 2,759 kPa, or 3,448 kPa.

The gas phase reactor can be capable of producing greater than 10 kg per hour (kg/hr), greater than 455 kg/hr, greater than 4,540 kg/hr, greater than 11,300 kg/hr, greater than 15,900 kg/hr, greater than 22,700 kg/hr, or greater than 29,000 kg/hr to 45,500 kg/hr of polymer, 70,000 kg/hr, 100,000 kg/hr, or 150,000 kg/hr.

In some embodiment, the polymer product can have a melt index ratio (I_{21.6}/I_{2.16}) ranging from 10 to less than 300, or, in many embodiments, from 20 to 66. The melt index (I_{2.16}) can be measured according to ASTM D-1238-13, condition E (190° C., 2.16 kg), and also referred to as “12(190° C./2.16 kg)”. The melt index (I_{21.6}) can be measured according to ASTM D-1238-13, condition F (190° C., 21.6 kg), and also referred to as “121.6 (190° C./21.6 kg)”.

In some embodiments, the polymer product can have a density ranging from 0.89 g/cm³, 0.90 g/cm³, or 0.91 g/cm³ to 0.95 g/cm³, 0.96 g/cm³, or 0.97 g/cm³. Density can be determined in accordance with ASTM D-792-20. In some embodiments, the polymer product can have a bulk density of from 0.25 g/cm³ to 0.5 g/cm³. For example, the bulk density of the polymer can be from 0.30 g/cm³, 0.32 g/cm³, or 0.33 g/cm³ to 0.40 g/cm³, 0.44 g/cm³, or 0.48 g/cm³. The bulk density can be measured in accordance with ASTM D-1895-17 method B.

In some embodiments, the polymerization process can include contacting one or more olefin monomers with a catalyst feed that can include mineral oil and catalyst particles. The one or more olefin monomers can be ethylene and/or propylene and the polymerization process can include heating the one or more olefin monomers and the catalyst system to 70° C. or more to form ethylene polymers or propylene polymers.

Monomers useful herein include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer can include ethylene and one or more optional comonomers selected from C₃ to C₄₀ olefins, such as C₄ to C₂₀ olefins, such as C₆ to C₁₂ olefins. Suitable C₄ to C₄₀ olefin monomers can be linear, branched, or cyclic. The C₄ to C₄₀ cyclic olefins may be strained or unstrained, monocyclic or polycyclic, and may optionally include heteroatoms and/or one or more functional groups. In at least one embodiment, the monomer can include ethylene and an optional comonomer that can include one or more C₃ to C₄₀ olefins, such as C₄ to C₂₀ olefins, such as C₆ to C₁₂ olefins.

In some embodiments, the C₂ to C₄₀ alpha olefin monomer and optional comonomer(s) include ethylene, propylene, butene, pentene, hexene, heptene, octene, nonene, decene, undecene, dodecene, norbomene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbomene, norbornadiene, and their respective homologs and derivatives, such as norbomene, norbornadiene, and dicyclopentadiene.

In at least one embodiment, one or more dienes can be present in the polymer product at up to 10 wt %, such as at 0.00001 wt % to 1.0 wt %, such as 0.002 wt % to 0.5 wt %, such as 0.003 wt % to 0.2 wt %, based upon the total weight of the composition. In at least one embodiment 500 ppm or less of diene is added to the polymerization, such as 400 ppm or less, such as 300 ppm or less. In other embodiments at least 50 ppm of diene is added to the polymerization, or 100 ppm or more, or 150 ppm or more.

Diene monomers include any hydrocarbon structure, such as C₄ to C₃₀, having at least two unsaturated bonds, where at least two of the unsaturated bonds are readily incorporated into a polymer by either a stereospecific or a non-stereospecific catalyst(s). The diene monomers can be selected from alpha, omega-diene monomers (i.e. di-vinyl monomers). The diolefin monomers are linear di-vinyl monomers, such as those containing from 4 to 30 carbon atoms. Examples of dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Cyclic dienes include cyclopentadiene, vinylnorbornene, norbomadiene, ethylidene norbomene, divinylbenzene, dicyclopentadiene or higher ring containing diolefins with or without substituents at various ring positions.

In at least one embodiment, the catalyst disclosed herein can be capable of producing ethylene polymers having a weight average molecular weight (Mw) from 40,000 g/mol, 70,000 g/mol, 90,000 g/mol, or 100,000 g/mol to 200,000 g/mol, 300,000 g/mol, 600,000 g/mol, 1,000,000 g/mol, or 1,500,000 g/mol. The Mw can be determined using Gel Permeation Chromatography (GPC). For the GPC data, the differential refractive index (DRI) method is preferred for Mn, while light scattering (LS) is preferred for Mw and Mz. The GPC can be performed on a Waters 150C GPC instrument with DRI detectors. GPC Columns can be calibrated by running a series of narrow polystyrene standards. Molecular weights of polymers other than polystyrenes are conventionally calculated by using Mark Houwink coefficients for the polymer in question.

The ethylene polymers may have a melt index (MI) of 0.2 g/10 min or greater, such as 0.4 g/10 min or greater, 0.6 g/10 min or greater, 0.7 g/10 min or greater, 0.8 g/10 min or greater, 0.9 g/10 min or greater, 1.0 g/10 min or greater, 1.1 g/10 min or greater, or 1.2 g/10 min or greater. In some embodiments, upper limit of MI of the ethylene polymers may be any one of 2.5, 3.0, 3.5, 4.0, 4.5, 5.0, or 5.5 g/10 min.

“Catalyst productivity” is a measure of how many grams of polymer (P) are produced using a polymerization catalyst comprising W g of catalyst (cat), over a period of time of T hours; and can be expressed by the following formula: P/(T×W) and expressed in units of gPgcat⁻¹ hr⁻¹. In at least one embodiment, the productivity of the catalysts disclosed herein can be at least 50 gPgcat⁻¹ hr⁻¹ or more, such as 500 gPgcat⁻¹ hr⁻¹ or more, such as 800 gPgcat⁻¹ hr⁻¹ or more, such as 5,000 gPgcat⁻¹ hr⁻¹ or more, such as 6,000 gPgcat⁻¹ hr⁻¹ or more.

While gas phase polymerization processes are described above, it should be understood that other polymerization processes, which are well-known in the art, can also be used to produce the polymer product. In some embodiments, any suspension, homogeneous, bulk, solution, slurry, and/or other gas phase polymerization process known in the art can be used. Such processes can be run in a batch, semi-batch, or continuous mode. A homogeneous polymerization process is defined to be a process where at least about 90 wt % of the product is soluble in the reaction medium. A bulk process is defined to be a process where monomer concentration in all feeds to the reactor is 70 volume % or more. Alternately, no solvent or diluent is present or added in the reaction medium, (except for the small amounts used as the carrier for the catalyst or other additives, or amounts typically found with the monomer; e.g., propane in propylene).

While gas phase polymerization processes are described above, it should be understood that other polymerization processes that are well-known in the art can also be used to produce the polymer product. Any suspension, homogeneous, bulk, solution, or slurry polymerization process known in the art can be used. Such processes can be run in a batch, semi-batch, or continuous mode. A homogeneous polymerization process is defined to be a process where at least about 90 wt % of the product is soluble in the reaction medium. A bulk process is defined to be a process where monomer concentration in all feeds to the reactor is 70 volume % or more. Alternately, no solvent or diluent is present or added in the reaction medium, (except for the small amounts used as the carrier for the catalyst system or other additives, or amounts typically found with the monomer; e.g., propane in propylene or ethane in ethylene).

In some embodiments, the polymerization process can be a slurry polymerization process, preferably a continuous slurry loop polymerization reaction process. A single slurry loop reactor can be used, or multiple reactors in parallel or series (although, to achieve a unimodal molecular weight distribution it can be preferable that either a single reactor is used, or that the same catalyst, feed, and reaction conditions are used in multiple reactors, e.g., in parallel, such that the polymer product is considered made in a single reactive step). As used herein, the term “slurry polymerization process” means a polymerization process in which a supported catalyst is used and monomers are polymerized on the supported catalyst particles within a liquid medium (comprising, e.g., inert diluent and unreacted polymerizable monomers), such that a two-phase composition including polymer solids and the liquid circulate within the polymerization reactor. Typically, a slurried tank or slurry loop reactor can be used; in particular embodiments herein, a slurry loop reactor is preferred. In such processes the reaction diluent, dissolved monomer(s), and catalyst can be circulated in a loop reactor in which the pressure of the polymerization reaction is relatively high. The produced solid polymer is also circulated in the reactor. A slurry of polymer and the liquid medium may be collected in one or more settling legs of the slurry loop reactor from which the slurry is periodically discharged to a flash chamber where the mixture can be flashed to a comparatively low pressure; as an alternative to settling legs, in other examples, a single point discharge process can be used to move the slurry to the flash chamber. The flashing results in substantially complete removal of the liquid medium from the polymer, and the vaporized polymerization diluent (e.g., isobutane) can then be recompressed in order to condense the recovered diluent to a liquid form suitable for recycling as liquid diluent to the reactor.

Slurry polymerization processes can include those described in U.S. Pat. No. 6,204,344 (hereafter the “'344 patent”). Other non-limiting examples of slurry processes include continuous loop or stirred tank processes. Also, other examples of slurry processes include those described in U.S. Pat. No. 4,613,484. In still other embodiments, the polymerization process can be a multistage polymerization process where one reactor is operating in slurry phase that feeds into a reactor operating in a gas phase as described in U.S. Pat. No. 5,684,097.

### Examples

The foregoing discussion can be further described with reference to the following non-limiting examples.

Two comparative (CEx. 1 and CEx. 2) and two inventive (Ex. 1 and Ex. 2) polymerization processes were carried out in a gas phase polymerization reactor. The reactor had an internal volume of 586 m³. The monomers fed into the reactor were ethylene (C2) and hexene (C6). 50 ppmw of a continuity additive was used in all examples. The first and second catalysts used in all examples were rac/meso dimethylsilylbis[(trimethylsilylmethyl)cyclopentadienyl]hafnium dimethyl, and rac/meso bis(1-methylindenyl)zirconium dimethyl, respectively. In particular, a slurry catalyst mixture (comprising the contact product of both of these metallocene catalyst compounds, silica support, and activators in carrier liquid) was blended with a trim catalyst solution (comprising the contact product of only the second metallocene catalyst (i.e., the zirconocene) and activator in carrier liquid) in the amounts indicated for each example in the Tables below. The carrier liquid for the slurry was a 50-50 preblend of (1) Hydrobrite-380 (HB-380) mineral oil (Sonneborn) and (2) SonoJell® #4 (Sonnebom), which itself is an 85:15 blend of HB-1000 mineral oil and wax (G1958 grease, which has a microcrystalline wax); the carrier liquid for solution included the HB-380 mineral oil. “Trim catalyst” refers to the in-solution catalyst, while “solid catalyst” refers to the supported catalysts from the slurry catalyst mixture.

Slurry and trim catalyst mixtures were combined upstream of each nozzle as indicated, with feed rates of each (and total feed rates) per nozzle indicated below in Tables 1 and 2. Just downstream of this, ICA and N₂ were added to the nozzle such that the ICA and N₂ mixed with slurry and trim catalyst at the start of the nozzle. The induced condensing agent (ICA) for all examples was iso-pentane. The slurry and trim solution were mixed together, and ICA mixed with those at the start of each nozzle. Monomer and H₂ were fed through the nozzle's outermost annulus (support tube), and did not mix with the catalyst slurry/catalyst trim/ICA/N₂ until exiting each nozzle. Continuity additive was added into the reactor separately.

Tables 1 and 2 below show certain process conditions including flow rates of these various components through 1, 2, or 3 nozzles into the reactor. Table 3 shows additional process conditions, polymer product properties, and the amount of polymer buildup observed in the examples.

TABLE 1
Process Conditions

| Parameter | units | CEx. 1 | Ex. 1 | CEx. 2 | Ex. 2 |
|---|---|---|---|---|---|
| C2 = flow | kg/hr | 24900 | 25900 | 27100 | 28900 |
| C6 = flow | kg/hr | 2565 | 2694 | 2493 | 2110 |
| C6 = /C2 = flow ratio | kg/kg | 0.103 | 0.104 | 0.092 | 0.073 |
| H2/C2 = gas ratio | ppm/mol % | 5.9 | 3.3 | 4.1 | 3.9 |
| Continuity Additive Concentration | ppm | 50 | 50 | 50 | 50 |
| Nozzle 1 flowmeter | kg/hr | 11.8 | 8.3 | 0 | 10.1 |
| Nozzle 2 flowmeter | kg/hr | 0 | 7.1 | 15.3 | 3.7 |
| Nozzle 3 flowmeter | kg/hr | 10.4 | 8.2 | 11.5 | 10.4 |
| Total based on nozzle flowmeters | kg/hr | 22.2 | 23.6 | 26.8 | 24.2 |
| Nozzle 1% flow | | 53% | 35% | 0% | 42% |
| Nozzle 2% flow | | 0% | 30% | 57% | 15% |
| Nozzle 3% flow | | 47% | 35% | 43% | 43% |
| Slurry catalyst feed rate | kg/hr | 20.5 | 23.0 | 26.4 | 25.2 |
| Slurry catalyst wt % solids | wt % | 19.0% | 19.0% | 19.0% | 19.0% |
| umol of metallocene catalyst per g | μmol/g | 25.0 | 25.0 | 28.6 | 28.6 |
| supported cat | | | | | |
| Moles/hr catalyst feed not including | mol/hr | 0.10 | 0.11 | 0.14 | 0.14 |
| catalyst in trim solution | | | | | |
| Trim solution feed rate | kg/hr | 3.1 | 3.5 | 1.9 | 1.3 |
| Trim solution wt % catalyst concentration | wt % | 0.6% | 0.6% | 0.6% | 0.6% |
| Moles/hr catalyst feed in trim | mol/hr | 0.05 | 0.06 | 0.03 | 0.02 |
| Total moles/hr catalyst feed, slurry + trim | mol/hr | 0.15 | 0.16 | 0.17 | 0.16 |
| Ratio of trim catalyst/solid (supported) | kg/hr | 0.005 | 0.005 | 0.002 | 0.002 |
| catalyst in slurry | | | | | |
| ICA feed rate per nozzle | | | | | |
| Nozzle 1 | kg/hr | 14 | 17 | 0 | 24 |
| Nozzle 2 | kg/hr | 15 | 16 | 13 | 13 |
| Nozzle 3 | kg/hr | 14 | 17 | 16 | 22 |
| N2 feed rate per nozzle | | | | | |
| Nozzle 1 | kg/hr | 11 | 13.5 | 0 | 11 |
| Nozzle 2 | kg/hr | 0 | 12.5 | 11 | 7 |
| Nozzle 3 | kg/hr | 10 | 12.5 | 11 | 12 |
| Distribution of slurry + trim (catalyst- | | | | | |
| containing mixture) among nozzles | | | | | |
| Nozzle 1 | wt % | 53 | 35 | 0 | 42 |
| Nozzle 2 | wt % | 0 | 30 | 57 | 15 |
| Nozzle 3 | wt % | 47 | 35 | 43 | 43 |
| Support tube feed rate per nozzle | | | | | |
| Nozzle 1 | kg/hr | 200 | 200 | 200 | 200 |
| Nozzle 2 | kg/hr | 208 | 207 | 199 | 207 |
| Nozzle 3 | kg/hr | 200 | 200 | 201 | 200 |

TABLE 2
Process Conditions Continued

| Parameter | units | CEx. 1 | Ex. 1 | CEx. 2 | Ex. 2 |
|---|---|---|---|---|---|
| Total carrier liquid per nozzle | | | | | |
| (ICA + non-catalyst portion of slurry catalyst | | | | | |
| feed + non-catalyst portion of trim solution feed) | | | | | |
| Nozzle 1 | kg/hr | 24.5 | 24.8 | 0.0 | 33.1 |
| Nozzle 2 | kg/hr | n/a | 22.7 | 26.5 | 16.2 |
| Nozzle 3 | kg/hr | 23.2 | 24.7 | 26.3 | 31.6 |
| Total catalyst flow per nozzle | | | | | |
| Nozzle 1 | kg/hr | 2.080 | 1.544 | none | 2.002 |
| Nozzle 2 | kg/hr | none | 1.321 | 2.870 | 0.733 |
| Nozzle 3 | kg/hr | 1.833 | 1.526 | 2.157 | 2.061 |
| Total molar catalyst flow per nozzle | | | | | |
| Nozzle 1 | mol/hr | 0.08 | 0.06 | 0.00 | 0.07 |
| Nozzle 2 | mol/hr | none | 0.05 | 0.10 | 0.02 |
| Nozzle 3 | mol/hr | 0.07 | 0.06 | 0.07 | 0.07 |
| Carrier liquid/catalyst ratio | | | | | |
| Nozzle 1 | kg/kg | 11.8 | 16.0 | n/a | 16.5 |
| Nozzle 2 | kg/kg | n/a | 17.1 | 9.2 | 22.1 |
| Nozzle 3 | kg/kg | 12.7 | 16.2 | 12.2 | 15.3 |
| Carrier liquid/molar catalyst ratio | | | | | |
| Nozzle 1 | kg/mol | 315 | 429 | n/a | 503 |
| Nozzle 2 | kg/mol | n/a | 458 | 268 | 674 |
| Nozzle 3 | kg/mol | 339 | 432 | 353 | 468 |

TABLE 3
Conditions, Polymer Properties, and Polymer Buildup

| Parameter | units | CEx. 1 | Ex. 1 | CEx. 2 | Ex. 2 |
|---|---|---|---|---|---|
| Reactor production | tonnes/hr | 25.5 | 27.0 | 27.3 | 28.2 |
| rate | | | | | |
| Reactor temperature | ° C. | 78 | 79 | 78 | 78 |
| Melt Index | I_{2.16} | 2.20 | 0.80 | 0.85 | 0.80 |
| Polymer density | g/cm³ | 0.924 | 0.921 | 0.923 | 0.925 |
| Melt index ratio | I_{21.6}/I_{2.16} | 34 | 32 | 30 | 28 |
| Sheeting bins filled | # of bins | 3.9 | 1.1 | 8 | 0.5 |
| previous 12 hours | | | | | |
| Sheeting estimated | kg | 975 | 275 | 2,000 | 125 |
| weight previous 12 | | | | | |
| hours | | | | | |
| Sheeting as wt % of | wt % | 0.32 | 0.08 | 0.61 | 0.04 |
| total PE production | | | | | |
| rate | | | | | |

As can be seen in Table 3, Ex. 1 reduced the amount of polymer buildup (sheeting) by about 3.5 times during the previous 12 hours as compared to CEx. 1 (975 kg vs. only 275 kg). As can also be seen in Table 3, Ex. 2 reduced the amount of polymer buildup (sheeting) by about 16 times during the previous 12 hours as compared to CEx. 2 (2,000 kg vs. only 125 kg). The significant reduction in polymer buildup was accomplished by making a minor adjustment (approximately 25%, depending on which nozzle) in the carrier liquid/catalyst ratio (kg/kg). Such a significant reduction in polymer buildup by making the minor adjustment in the carrier liquid/catalyst ratio (kg/kg) was surprising and unexpected.

### Listing of Embodiments

This disclosure can further include the following non-limiting embodiments.

B1. A polymerization process, comprising: introducing a carrier fluid, an olefin, and a catalyst feed, said catalyst feed comprising one or more catalysts, a carrier liquid, and, optionally, an induced condensing agent, into a polymerization reactor, wherein a combined amount of the carrier liquid and any induced condensing agent in the catalyst feed is equal to a first amount per mole of the catalyst introduced into the polymerization reactor; polymerizing the olefin in the presence of the one or more catalysts within the polymerization reactor to produce a polymer product, wherein polymer sheets are formed within the polymerization reactor at a rate greater than a pre-determined rate of polymer sheet formation; and reducing the rate of polymer sheet formation within the polymerization reactor by increasing the combined amount of the carrier liquid and any induced condensing agent in the catalyst feed to a second amount per mole of the catalyst introduced into the polymerization reactor, wherein the second amount is sufficient to reduce the rate of polymer sheet formation to less than the pre-determined rate. As used herein, a “pre-determined rate” of sheeting does not necessarily need to be a specific amount of sheeting, but instead should be viewed akin to a set-point, e.g., a determined amount (whatever that amount may be) beyond which the operator deems sheeting to be unacceptable. The skilled artisan operating a polymerization reactor will be able to apply ordinary skill to arrive at a pre-determined maximum allowable or desired amount of sheeting.

B2. The process of B1, wherein the first amount is <350 kg per mole of the catalyst, and wherein the second amount is ≥350 kg of the carrier liquid per mole of the catalyst.

B3. The process of B1, wherein the first amount is <400 kg per mole of the catalyst, and wherein the second amount is ≥400 kg of the carrier liquid per mole of the catalyst.

B4. The process of B1, wherein the first amount is ≤375 kg per mole of the catalyst, and wherein the second amount is ≥415 kg of the carrier liquid per mole of the catalyst.

B5. The process of B1, wherein the first amount is ≤360 kg per mole of catalyst, and wherein the second amount is ≥425 kg of the carrier liquid per mole of the catalyst.

B6. The process of any of B1 to B5, wherein the second amount is ≤1,700 kg of the carrier liquid per mole of the catalyst.

B7. The process of any of B1 to B6, wherein a weight ratio of the combined amount of the carrier liquid and any induced condensing agent in the catalyst feed to the catalyst in the first amount is <13:1, and wherein a weight ratio of the combined amount of the carrier liquid and any induced condensing agent in the catalyst feed to the catalyst in the second amount is ≥13:1, preferably ≥14:1, more preferably ≥15:1, even more preferably ≥16:1.

B8. The process of B7, wherein the weight ratio of the combined amount of the carrier liquid and any induced condensing agent in the catalyst feed to the catalyst in the second amount is ≤50:1.

B9. The process of any of B1 to B8, wherein the pre-determined rate of polymer sheet formation is ≥0.3%, preferably ≥0.1%, of a total polymer product production rate.

B10. The process of any of B1 to B9, wherein the carrier liquid comprises a mineral oil.

B11. The process of any of B1 to B10, wherein the carrier liquid comprises a mineral oil and a wax.

B12. The process of B11, wherein the wax comprises a paraffin wax.

B13. The process of B11 or B12, wherein the carrier liquid comprises ≥1 wt % of the wax, preferably 2 wt % to 15 wt % of the wax, based on a total weight of the carrier liquid.

B14. The process of any of B1 to B13, wherein the carrier liquid comprises a mineral oil and a wax, and wherein the catalyst feed includes the induced condensing agent.

B15. The process of B14, wherein the induced condensing agent comprises propane, isobutane, isopentane, isohexane, or a mixture thereof.

B16. The process of B14 or B15, wherein a combined feed rate of the mineral oil, the wax, and the induced condensing agent in the catalyst feed into the polymerization reactor comprises 8 wt % to 68 wt % of the mineral oil, 2 wt % to 15 wt % of the wax, and 30 wt % to 90 wt % of the induced condensing agent in the catalyst feed, based on the combined feed rate of the mineral oil, the wax, and the induced condensing agent in the catalyst feed.

B17. The process of any of B1 to B16, wherein the catalyst feed is formed by combining two or more catalyst-containing mixtures.

B18. The process of B17, wherein the two or more catalyst-containing mixtures comprise a slurry catalyst mixture and a solution catalyst mixture; further wherein the slurry catalyst mixture comprises a contact product of a first metallocene catalyst compound, a second metallocene catalyst compound, a support, an activator, and the carrier liquid.

B19. The process of B18, wherein the support comprises silica and/or the activator comprises an aluminoxane.

B20. The process of any of B18 to B19, wherein the first catalyst comprises rac/meso dimethylsilylbis[(trimethylsilylmethyl)cyclopentadienyl]hafnium dimethyl and the second catalyst comprises rac/meso bis(1-methylindenyl)zirconium dimethyl.

B21. The process of any of B18 to B20, wherein the catalyst feed comprises about 1 wt % to about 40 wt % of a combined amount of the first catalyst and the second catalyst, based on a total weight of the catalyst-containing mixture, and wherein the catalyst-containing mixture is introduced into the polymerization reactor at a flow rate of ≥0.1 kg/hr per cubic meter of polymerization reactor volume to 0.5 kg/hr per cubic meter of polymerization reactor volume

B22. The process of any of B1 to B21, wherein the olefin comprises ethylene or ethylene and one or more comonomers, and wherein the olefin is introduced into the polymerization reactor at a flow rate of about 40 kg/hr per cubic meter of polymerization reactor volume to about 125 kg/hr per cubic meter of polymerization reactor volume.

B23. The process of any of B1 to B22, wherein the polymerization reactor comprises a gas phase polymerization reactor.

B24. The process of any of B1 to B23, wherein the polymerization reactor comprise a slurry phase polymerization reactor.

B25. The process of any of B1 to B24, wherein the carrier fluid comprises nitrogen, argon, ethane, propane, or a mixture thereof.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A polymerization process, comprising:
introducing a carrier fluid, an olefin, and a catalyst feed into a polymerization reactor, wherein the catalyst feed comprises one or more catalysts, a carrier liquid and optionally an induced condensing agent, and further wherein a combined amount of the carrier liquid and any induced condensing agent in the catalyst feed is ≥350 kg per mole of the one or more catalysts introduced into the polymerization reactor; and
polymerizing the olefin in the presence of the one or more catalysts within the polymerization reactor to produce a polymer product.

2. The process of claim 1, wherein the combined amount of the carrier liquid and any induced condensing agent in the catalyst feed is ≥375 kg per mole of the one or more catalysts.

3. The process of claim 1, wherein the combined amount of the carrier liquid and any induced condensing agent in the catalyst feed is ≤1,350 kg per mole of the one or more catalysts.

4. The process of claim 1, wherein a weight ratio of the combined amount of the carrier liquid and any induced condensing agent in the catalyst feed to the one or more catalysts is ≥13:1.

5. The process of claim 1, wherein the weight ratio of the combined amount of the carrier liquid and any induced condensing agent in the catalyst feed to the one or more catalysts is ≤50:1.

6. The process of claim 1, wherein polymer sheets are formed within the polymerization reactor at a rate of ≤0.3% based on a total polymer product production rate.

7. The process of claim 1, wherein the carrier liquid comprises a mineral oil and, optionally, a wax.

8. The process of claim 7, wherein the carrier liquid comprises the mineral oil and the wax, and wherein the carrier liquid comprises ≥1 wt % of the wax, based on a total weight of the carrier liquid.

9. The process of claim 1, wherein the catalyst feed includes the induced condensing agent.

10. The process of claim 9, wherein the induced condensing agent comprises propane, isobutane, isopentane, isohexane, or a mixture thereof

11. The process of claim 1, wherein:
the carrier liquid comprises a mineral oil and a wax,
the catalyst feed includes the induced condensing agent, and
a combined feed rate of the mineral oil, the wax, and the induced condensing agent in the catalyst feed into the polymerization reactor comprises 8 wt % to 68 wt % of the mineral oil, 2 wt % to 15 wt % of the wax, and 30 wt % to 90 wt % of the induced condensing agent, based on the combined feed rate of the mineral oil, the wax, and the induced condensing agent in the catalyst feed.

12. The process of claim 1, wherein the catalyst feed is formed by combining two or more catalyst-containing mixtures.

13. The process of claim 12, wherein the two or more catalyst-containing mixtures comprise a slurry catalyst mixture and a solution catalyst mixture; further wherein the slurry catalyst mixture comprises a contact product of a first metallocene catalyst compound, a second metallocene catalyst compound, a support, an activator, and the carrier liquid.

14. The process of claim 13, wherein the support comprises a silica, and wherein the activator comprises an alumoxane.

15. The process of claim 13, wherein the first metallocene catalyst comprises rac/meso dimethylsilylbis[(trimethylsilyl)methyl)cyclopentadienyl]hafnium dimethyl and the second metallocene catalyst comprises rac/meso bis(1-methylindenyl)zirconium dimethyl.

16. The process of claim 12, wherein the catalyst feed comprises about 1 wt % to about 40 wt % of solids, based on a total weight of the catalyst feed, and wherein the catalyst feed is introduced into the polymerization reactor at a flow rate of ≥0.1 kg/hr per cubic meter of polymerization reactor volume to 0.5 kg/hr per cubic meter of polymerization reactor volume.

17. The process of claim 16, wherein the olefin comprises ethylene and, optionally, one or more comonomers, and wherein the olefin is introduced into the polymerization reactor at a flow rate of about 40 kg/hr per cubic meter of polymerization reactor volume to about 125 kg/hr per cubic meter of polymerization reactor volume.

18. The process of claim 17, wherein the catalyst feed is introduced into the polymerization reactor at a flow rate of ≥0.11 kg/hr per cubic meter of polymerization reactor volume.

19. The process of claim 1, wherein the polymerization reactor is a gas phase polymerization reactor or a slurry phase polymerization reactor.

20. (canceled)

21. The process of claim 1, wherein the carrier fluid comprises nitrogen, argon, ethane, propane, or a mixture thereof.
